(19) United States
(12) Patent Application Publication
(10) Pub. No.: US 2010/0086374 A1
(43) Pub. Date: Apr. 8, 2010

(54) DYNAMICALLY OPTIMIZED MACHINE TOOL HAVING SUPERIMPOSED DRIVE SYSTEMS

(76) Inventor: Jurgen Roders, Soltau (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/614,151

(22) Filed: Nov. 6, 2009

Related U.S. Application Data
(63) Continuation of application No. PCT/EP2008/003593, filed on May 5, 2008.

(30) Foreign Application Priority Data
May 7, 2007 (DE) 102007021294.3

(51) Int. Cl. B23Q 15/013

(52) U.S. Cl. 409/132

(57) ABSTRACT

The invention relates to a method for controlling movement of at least one subassembly of a machine tool, wherein the subassembly includes a rotatable spindle supported at the subassembly by at least one magnetic bearing having at least one bearing gap, wherein the subassembly is moved along a path smoothed by a controller with respect to an exact path, wherein the spindle in its housing is moved along a differential path by means of the magnetic bearing, and wherein the addition (superimposition) of the smoothed path and the differential path generated therewith results in the exact path.

### CROSS-REFERENCE TO RELATED APPLICATIONS

This is a continuation application of international patent application number PCT/EP08/003593 filed on May 5, 2008, and claims priority to German Patent App. No. 10 2007 021 294.3 filed on May 7, 2007. The entire contents of both prior-filed patent applications are incorporated herein by reference.

### FIELD OF THE INVENTION

The invention relates to a modern, controlled machine tool.

### BACKGROUND

Conventional modern, controlled machine tools are typically structured to have multiple axes. A processing tool is moved relative to a workpiece by corresponding movements of individual axes of the machine tool, in order to perform the required processing of the workpiece.

In case of complicated contours, very dynamic movements are required to be performed by the individual axes of the machine tool. In order to obtain short processing periods, the movements should be performed as fast and dynamically as possible. Simultaneously, high precision and/or high surface quality of the workpiece is required.

In addition, there exists a maximum possible process-related path speed for relative movement between the tool and the workpiece (e.g., the maximum admissible infeed per tooth in the case of milling processes).

When producing high precision workpieces and/or high surface qualities, the maximum possible path speed, in most cases, is not so much limited by the processing step, but by the dynamics of the tool machine. The higher the dynamics of the machine tool, the higher the path speed at which sufficiently good precision and surface quality can still be maintained.

In order to obtain processing periods that are as short as possible, it is known to use a controller that generates a path plan by means of a look ahead window and that automatically adapts the relative path speed in accordance with the geometry of the path, e.g. by reducing the speed at locations within the path having large curvature, and using the maximum admissible path speed at locations having less or no curvature. A modern controller will configure the path plan such that the machine tool will proceed with the highest possible path speed at any location in the processing program, while observing the requirements concerning precision and surface quality.

The better and more rigid the construction of the machine tool, the faster the admissible path speed at any location in the processing program at which quality requirements can still be obtained. Consequently, a construction that is as rigid as possible and is adapted to be highly dynamic is the object of the machine constructions.

A substantial limitation of the dynamics of modern machine tools lies in the fact that the individually movable machine axes require a certain installation size in order to obtain sufficient rigidity and a required travelling path. Due to this, the individual machine axes have relatively large masses which limit the dynamics of the axes considerably, in particular in case of axes that are superimposed on one another (e.g., the Y- and Z-axes in case of a portal milling machine). In this case, the Y-axis supports and moves the complete Z-axis. Attempts have been made to increase dynamics using different approaches with an eye toward light weight construction, but the possibilities in this respect are limited.

Especially when producing complicated contours, strictly limited machine dynamics may result in most processing being performed at path speeds which are far below the maximum possible process-related limit in order to obtain the required quality, even if modern control concepts for controlling the machine with a spline interpolation and optimum path planning are used.

Changes of curvature within the path require changes of acceleration, which are realized by the derivation of the acceleration over time, i.e. the “jerk”. The larger the changes of curvature, the larger the required changes of acceleration and the larger the required jerk in order to move along a path. However, when exceeding a specific jerk, this results in excitations of the machine and thus in vibrations and inaccuracies. Each machine has its maximum possible jerk defined for its axes in which the machine is still operable without reaching undesired excitations. In order to ensure that a specific jerk is not exceeded during processing, modern machine controllers plan the path speed such that jerk in the machine axes is always kept slightly below the maximum admissible limit for the machine. Therewith, an optimum processing time is obtained with a sufficient quality of the workpiece. In addition, planning of the path speed of course has to consider the maximum acceleration and decrease the speed in case of small radii of the path.

A certain reduction of processing time may, in addition, be obtained by a smoothing operation performed by the controller. The tool path is automatically smoothed with respect to the workpiece in accordance with tolerances predetermined by the user in order to enable a “softer” and therewith faster moving of the machine. Good smoothing by the controller decreases the jerk requirement on the axes in the machine by decreasing changes of curvature and small radii or sharp corners in the path as much as possible. However, such smoothing is performed at the expense of precision at the workpiece, and is therefore not possible or possible only to a very limited extent in many cases.

In case of high precision requirements, the contour of the workpiece has to be produced exactly in all details, and, accordingly, the tool path relative to the workpiece has to be traced exactly.

### SUMMARY

It is an object underlying the present invention to provide a method for controlling a machine tool which guarantees an optimisation of the course of motion and possible processing speeds while being simple in design and reliable in operation.

According to some embodiments of the invention, a division into different movement paths is performed, i.e. a smoothed path along which the subassembly of the machine tool (e.g. a milling machine) is moved, as well a differential path which enables movements of the spindle shaft and therewith movements of the tool connected to the spindle shaft.

Also according to some embodiments of the present invention, the machine tool (e.g. a milling machine) is provided with a processing spindle supported by a magnet. The magnet-supported spindle stands out due to the fact that the rotating spindle shaft is sustained in the spindle housing levitated in a defined position, i.e. without a mechanic contact by means of strong, controlled electro-magnets. Between the magnets of the bearings of the spindle and the spindle shaft, gaps are provided at all bearing locations. Within the dimensions of the gaps, the spindle shaft can be swayed freely within the spindle housing due to magnetic bearing control, wherein the gaps are usually kept very narrow in order to be able to generate large magnetic forces. However, a certain dimension of the gap is required, since the spindle shaft can be bounced out from its position by external interfering forces before the controller is able to compensate the interference. In such cases, it is important that no mechanic contact occurs between magnets and the spindle shaft in order to avoid damage. The gaps at the bearing locations have to be dimensioned sufficiently large that, in case of any occurring interfering forces, sufficient space is available for the maximum resulting deflection which occurs until the controller compensates for the interference.

The magnetic support of the spindle enables positioning, moving or dislocating of the spindle shaft within the gap dimensions of the magnetic bearings. The range of motion of the spindle shaft is defined by the gap dimensions of the magnetic bearings, and is therewith restricted to a very small space. Within this range of motion, however, the spindle shaft can be moved to any extent with very high dynamics due to the small dimensions. The magnetic support of the spindle shaft is extremely dynamic, in order to compensate for possible processing forces. These high dynamics are used in the invention to move the spindle shaft within its range of motion very dynamically.

The inventive machine tool provided with a magnetic spindle has two possible movements or travelling which can be superimposed, i.e. the machine axes having relatively large travelling paths but low dynamics, and the spindle shaft having very large dynamics but a very restricted range of motion in any direction.

The present invention utilizes the particularities of both movement or travelling possibilities of a machine tool having a magnetic spindle. The exact tool path which defines the relative motion between the processing tool and the workpiece is usually taken from a programming system, or is directly programmed into the controller.

The exactly programmed or otherwise predetermined tool path is divided into two paths in the controller of the machine, and is processed in parallel and interpolated:
into a smoothed path, wherein smoothing is performed with a fixedly predetermined maximum tolerance, and the aim of the smoothing is to decrease the changes of curvature in the path as far as possible within the predetermined tolerance, and also to eliminate or decrease sharp corners and small radii; and
into a differential path which, when added to the smoothed path, again results in the original exact path and generates very small travelling paths.

Since smoothing of the original path is performed with a fixedly predetermined maximum tolerance, the travelling path of the differential path is limited to a very small range of motion, the dimensions of which in each direction lie within the maximum tolerance predetermined for the smoothing.

Both paths (the smoothed path and the differential path) are interpolated in parallel in the controller. The target values for the smoothed path are transmitted to the drives for the machine axes, and the target values for the differential path are transmitted to the drives for the magnetic bearings. The travelling movements of the machine axes and the relatively small, but dynamic travelling movements of the spindle shaft in the magnet-supported milling spindle superimpose synchronously, and therewith result in an exact tool path as the relative motion between tool and workpiece. Consequently, it is important that the smoothing tolerance in each direction is smaller than the possible range of motion of the spindle shaft in the spindle housing, such that no contact occurs between the spindle shaft and the magnetic bearings.

An advantage of this procedure is that the overall processing time for both paths can be considerably reduced. The smoothed path can be passed by the machine axes with a considerably higher path speed than the exact path, since the reduction of the changes of curvature, small radii and sharp corners in the smoothed path results in considerably lower requirements on jerk and acceleration in the axes.

Movements having high jerk requirements and dynamics, however, have to be performed by the spindle shaft. Due to the aforementioned bearing technology, however, the spindle shaft is capable of perform this. The high jerk requirements also do not result in undesired excitations of the machine structure, since the mass of the spindle shaft is relatively small. Since the travelling movements of the differential path are restricted to a very small range of motion, the spindle shaft is capable of performing them completely.

The present invention enables a considerable reduction of processing times on the machine tools by means of an intelligent controlling of the individual components. Due to the high quality of control and dynamics of the magnet-supported spindle, this method can also be realized with highest precision requirements and surface qualities.

A reasonable further development of the procedure comprises predetermining separate tolerances for the different axis directions, depending on the maximum possible range of motion of the spindle shaft in each axis direction, if the same is different in the individual axis directions.

In case of machine axes dislocating the spindle shaft, e.g. the Y- and Z-axes in case of portal machines, the superimposition of the movements of the respective machine axis and the spindle shaft may be used for a momentum decoupling. The momentum decoupling is advantageous if extremely dynamic movements of the spindle shaft result in excitations of the machine structure, and therewith in inaccuracies or worse surfaces, despite the small mass of the spindle shaft. In this case, the exact path for the relative motion between processing tool and workpiece can be divided such that a relatively heavy machine axis not only traces the smoothed path, but the machine axis additionally performs a superimposed, very small but jerking counter-movement at the corresponding locations on the path at which the spindle shaft enters a jerk momentum into the axis due to the fast movement. The jerk momentum entered into the axis due to fast movement of the spindle shaft is thus compensated by an equally large counter-momentum, and therewith insures that an excitation of the machine frame is avoided. The counter-movement is, due to the large difference in masses, considerably smaller than the movement of the spindle shaft, such that a significant stroke at the tool also results. However, this can only be realized in the axes in which the spindle shaft and the axis directly influence each other, e.g. the Z-axis of the portal machine. In case of a table axis of the portal machine, this is hardly possible, since the complete machine frame is disposed between the table axis and the spindle, the excitation of which shall be avoided.

In case of specific geometries, an additional further development of the described procedure is advantageous, in order to obtain a best possible utilization of controlling of the axes and the magnet-supported spindle. Such a geometry includes sharp corners in the path, i.e. a reversal of direction without a tangential transition. In case of conventional machines, the machine proceeds into a corner with a brake ramp, stops for a very short moment, and accelerates from the corner, following the path into the new direction. If high accuracies are not important, the machine does not stop completely, and grinds down the corner. Normally, however, this is not desired.

Also in the aforementioned procedure in which the path is divided into a smoothed path and a differential path, which are both passed synchronously to realize the exact path at the workpiece, the machine must stop. The dynamics of the spindle shaft are very high. If, however, an exact corner including a switch in direction shall be traced in the path, then also the magnet-supported spindle shaft has to stop with a brake ramp in order to be able to accelerate again in the new direction. If, however, the spindle shaft reduces the path speed to zero, the machine axes also have to reduce the path speed to zero in case of a synchronous interpolation of the machine axes in order to avoid inaccuracies, although the smoothed path of the machine axes would not require this. In this case, the brake and acceleration ramps have to be geared to the relatively inertial machine axes, and the method would not be advantageous for such geometries. This, however, can be avoided if the differential path of the spindle shaft is planned such that same is not traced exactly synchronously, but the spindle shaft uses its range of motion additionally to move somewhat faster or slower, wherein the sum of both paths (the smoothed path and the differential path) still always results in the exact path. In case of a corner, this may have the effect that the spindle shaft moves slightly faster in front of the corner, in the corner moves, for a short time, with a speed exactly opposite to the machine axes, such that a relative standstill occurs between the tool and the workpiece for a short time, and then moves slightly slower when the corner is passed.

### BRIEF DESCRIPTION OF THE DRAWINGS

In the following, the invention is described on the basis of embodiments with reference to the accompanying drawings, in which:

FIG. 1 shows a schematic, perspective view of a machine tool used according to an embodiment of the invention,

FIG. 2 shows a schematic partial sectional view of a spindle bearing,

FIG. 3 shows a schematic view of an exact path and a smoothed path according to a first embodiment of the invention,

FIG. 4 shows a schematic view of an inventive differential path related to FIG. 3,

FIG. 5 shows a view, analogue to FIG. 3, of a further embodiment of an exact path and a related smoothed path according to the invention, and

FIG. 6 shows a view, analogue to FIG. 4, of a differential path according to the invention, matching the illustration of FIG. 5.

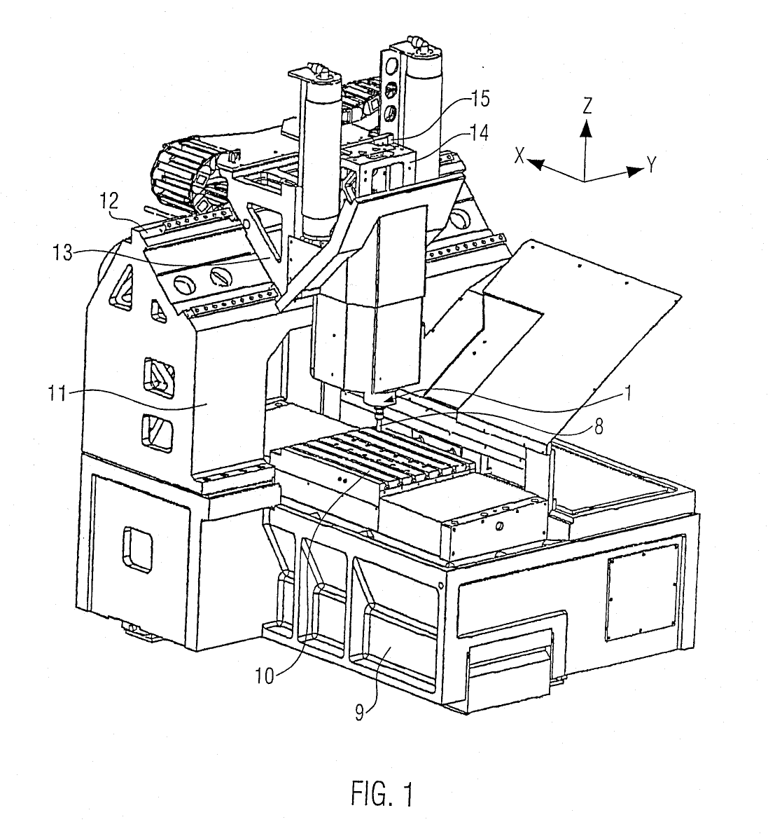

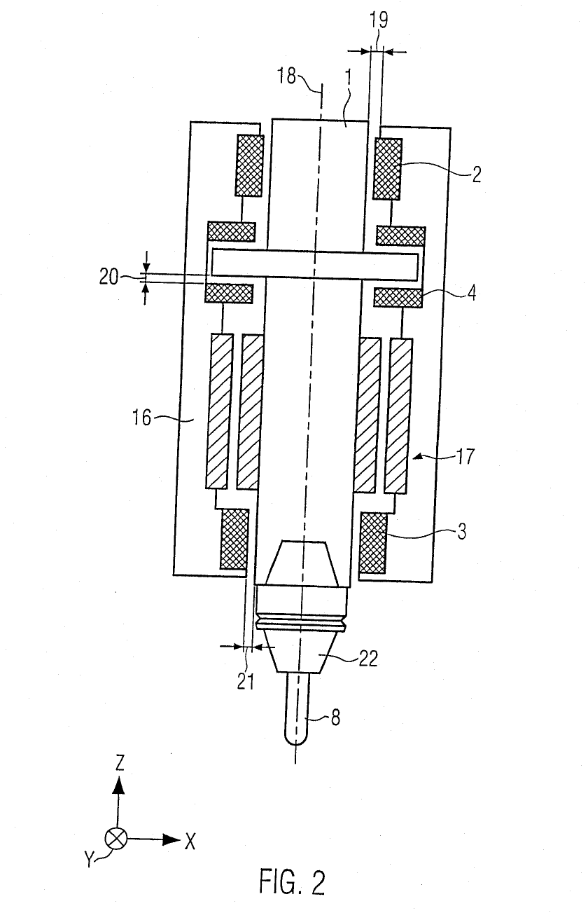

FIG. 1 schematically shows a perspective view of a machine frame of a portal milling machine as an example of a machine tool to be used according to the present invention. The portal milling machine comprises a spindle 1, the bearing of which is described in detail below in connection with FIG. 2. The spindle 1 is connected to a tool 8, such as a milling cutter. The structure of the particular tool receptacle as well as the individual components of the portal milling machine are conventional in nature. In FIG. 1, the depiction of a workpiece is omitted.

FIG. 1 also shows a machine frame 9 on which a machine table 10 can be moved along an X-axis. A portal 11 is attached to the frame 9, which is provided with guides 12 with which a movement of a carriage 13 in the Y-direction is possible. Guides 15 are formed at the carriage 13, along which another carriage 14 can be moved in the Z-direction. The carriage 14 supports the spindle 1.

The movement directions X-Y-Z form the X-axis, the Y-axis and the Z-axis, which underlie the controlling of the machine tool. The components, according to the present invention designated as subassemblies, comprise the carriage 13 for movement along the Y-axis, the carriage 14 for movement along the Z-axis, as well as the table 10 for movement along the X-axis.

FIG. 2 schematically shows the support of the spindle 1, which comprises a housing 16 integrated into the carriage 14. The spindle 1 is supported about its center axis 18. Support is obtained by magnetic bearings, i.e. by means of an upper radial magnetic bearing 2, a lower radial magnetic bearing 3, as well as an axial magnetic bearing 4.

As is known from the state of the art, the magnetic bearings 2, 3 and 4 respectively comprise bearing gaps which are required for operation of the magnetic bearings. Schematically, a bearing gap 19 for the upper radial magnetic bearing 2 as well as a gap 20 for the axial magnetic bearing 4 are shown in FIG. 2. A gap for the lower radial magnetic bearing 3 is designated with reference numeral 21.

The tool 8 is detachably supported at the spindle 1 by a tool holder 22 in any conventional manner.

The spindle 1 (spindle shaft) is rotated by a spindle motor 17.

The structure of the spindle 1 as shown in FIG. 2 corresponds to the state of the art.

FIG. 2 further shows the movement axes X, Y and Z according to the arrangement of FIG. 1.

According to some embodiments of the present invention, it is important that the spindle can be swayed freely by means of its magnetic bearings 2, 3, 4 within the respective bearing gaps 19, 20, 21 (as well as other bearing gaps which are not shown).

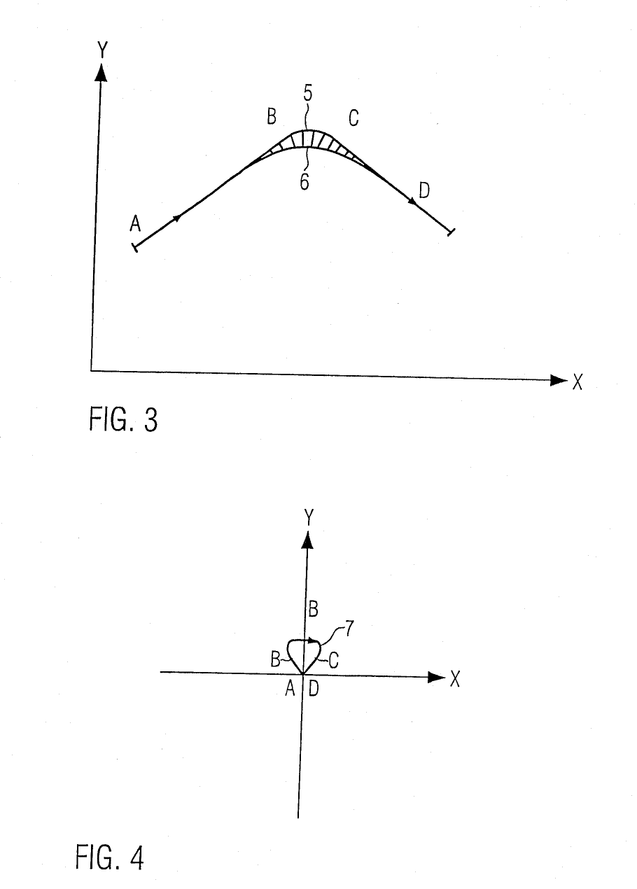

FIG. 3 graphically shows an exact movement path 5 in the X-Y-plane, including points A, B, C, D. The exact path 5, on which a reference point of the tool 8 shall move relative to a workpiece, at first passes along a straight line from A to B according to FIG. 3. Between points B and C, there is a circular section which merges into a straight path again at point C. Between points C and D, the path is straight again.

A path 6 smoothed with the predetermined tolerances according to the present invention, rounds or grinds down the exact path 5 and extends a distance from the exact path 5, in particular in the rounded portion between points B and C. In FIG. 3, cross bars are respectively drawn between the exact path 5 and the smoothed path 6, which show the respective synchronous target positions in the exact and smoothed paths.

The graphic illustration of FIG. 4 shows the course of a differential path 7, again including the positions of points A, B, C and D of FIG. 3. Further, FIG. 4 shows an arrow indicating the direction of the path.

FIG. 4 shows that the exact path 5 is generated by superimposition of the smoothed path 6 according to FIG. 3 and the differential path 7 according to FIG. 4.

In addition, it is discernible from FIGS. 3 and 4 that the differential path 7 is limited to a very small region, i.e. near the point of origin of the X-Y-diagram schematically shown in FIGS. 3 and 4. At the apex, both paths have the same direction (see arrows of motion in FIGS. 3 and 4).

It is obvious that FIGS. 3 and 4 only show a two-dimensional illustration for clarifying the depiction. According to the present invention, a three-dimensional movement with three-dimensional paths 5, 6 and 7 can also be realized. The depiction is enlarged to a large extent to make it clearer. In practice, the smoothed path 6 would lie much closer to the exact path 5, and the region of the differential path 7 would be much smaller.

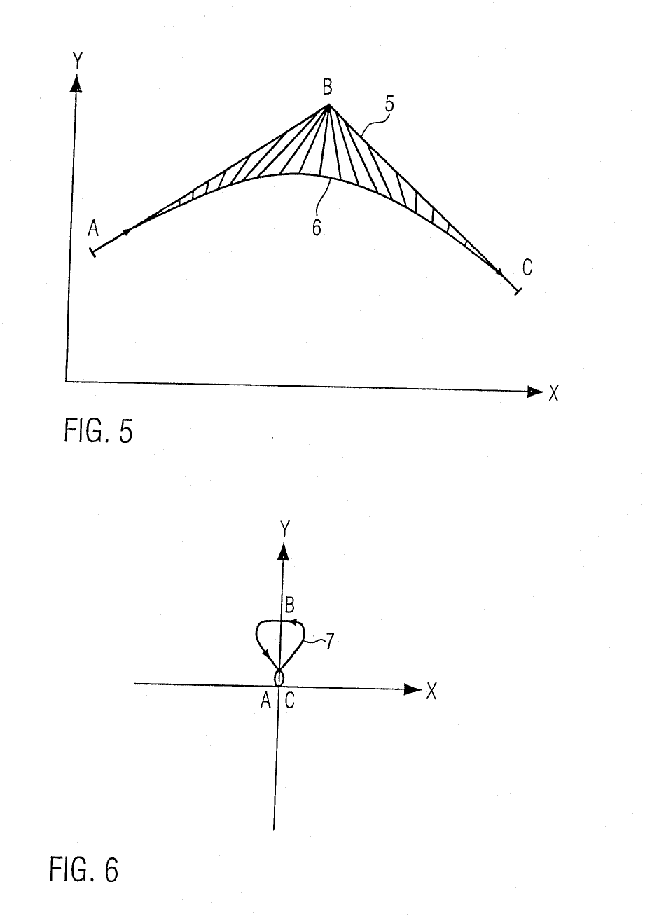

FIGS. 5 and 6 show illustrations analogous to FIGS. 3 and 4.

In the illustration of FIG. 5, the exact path 5 passes a sharp corner in point B upon a course of the exact path 5 from point A to point B and subsequently to point C. FIG. 5 shows the related course of the smoothed path 6. From the course and the shown cross connections, the synchronous target positions of the exact path 5 and the smoothed path 6 result.

Compared to the graphic illustration of FIG. 3, it results from FIG. 5 that the position of the smoothed path 6, at first, lags behind the position of the exact path 5. This changes at point B. Beginning at point B, the smoothed path 6 runs ahead of the exact path 5.

At position B, the speeds of the smoothed path 6 and the differential path 7 are exactly equal (see FIG. 6), but also exactly opposite, such that both speeds cancel each other, and the path speed of the exact path 5 becomes zero for a short period of time. The directions of the arrows in FIGS. 5 and 6 show the respective course of the paths.

Due to the short-term superimposition of two opposite, exactly equal speeds, the invention provides that a sharp corner (point B) is generated in the exact path 5. Simultaneously, it is prevented that the machine axes having relatively low dynamics have to reduce their speed to zero in the smoothed path 6.

It is obvious that the illustrations of FIGS. 3 to 5 are enlarged to a large extent, and are very schematic for the purpose of clarification.

The present invention is not limited to machines having two or three axes, but can also be used in machines having multiple axes, such as in movements of machines having five axes (e.g., machines including three linear axes and two rotational axes). The principle is the same. The illustrations of FIGS. 3 to 5 are only two-dimensional for the purpose of a simpler explanation. The method can be transferred to machines having any number of axes and any arrangement.

What is claimed is:

1. A method for controlling movement of at least one machine tool subassembly comprising a rotatable spindle supported at the subassembly by at least one magnetic bearing including at least one bearing gap, the method comprising:
moving the subassembly along a path smoothed by a controller with respect to an exact path; and
moving the spindle in a housing along a differential path by a magnetic bearing,
wherein superimposition of the smoothed path and the differential path generated therewith results in the exact path.

2. The method of claim 1, wherein the smoothed path and the differential path are formed two-dimensionally.

3. The method of claim 1, wherein the smoothed path and the differential path are formed three-dimensionally.

4. The method of claim 1, wherein the smoothed path and the differential path are formed multi-dimensionally for machines having multiple axes.

5. The method of claim 1, wherein the smoothed path is smoothed with a fixedly predefined maximum tolerance.

6. The method of claim 1, wherein the smoothed path and the differential path are interpolated by the controller in parallel to each other.

7. The method of claim 6, further comprising
transmitting to driving members of the subassembly target values of the smoothed path; and
transmitting to a driving means of the magnetic bearings target values of the differential path.

8. The method of claim 1, wherein a maximum tolerance for the smoothed path in each direction of movement is smaller than a maximum possible movement of the spindle within the gaps.

9. The method of claim 1, wherein the spindle shaft is moved with at least one of high dynamics and large acceleration along the differential path.

10. The method of claim 1, wherein different tolerances are predefined for at least one of the differential path and the smoothed path in different directions of movement.

11. The method of claim 1, wherein a momentum decoupling occurs by the superimposition of the smoothed path and the differential path.

12. The method of claim 11, further comprising performing a jerking counter-movement at a location of the exact path by means of the smoothed path, at which a fast movement is performed by means of the differential path.

13. The method of claim 1, wherein the exact path runs ahead of or lags behind the smooth path in respect to movements thereof.

14. The method of claim 1, for use in a milling machine.

15. The method of claim 2, wherein the smoothed path is smoothed with a fixedly predefined maximum tolerance.

16. The method of claim 3, wherein the smoothed path is smoothed with a fixedly predefined maximum tolerance.

17. The method of claim 4, wherein the smoothed path is smoothed with a fixedly predefined maximum tolerance.

18. The method of claim 2, wherein the smoothed path and the differential path are interpolated by the controller in parallel to each other.

19. The method of claim 3, wherein the smoothed path and the differential path are interpolated by the controller in parallel to each other.

20. The method of claim 4, wherein the smoothed path and the differential path are interpolated by the controller in parallel to each other.
